(19) United States
(12) Patent Application Publication
(10) Pub. No.: US 2007/0052181 A1
(43) Pub. Date: Mar. 8, 2007

(54) Backup ring

(75) Inventor: Takafumi Nakamura, Fukushima (JP)

Correspondence Address: Harness Dickey and Pierce PLC, P.O. Box 808, Bloomfield Hills, MI, 48303, US

(73) Assignee: NOK Corporation

(21) Appl. No.: 11/517,426

(22) Filed: Sep. 7, 2006

(30) Foreign Application Priority Data
Sep. 8, 2005 (JP) JP 2005-260278

(51) Int. Cl. F16J 15/00

(52) U.S. Cl. 277/584

(57) ABSTRACT

It is an object of the present invention to provide a backup ring capable of preventing the backup ring from being damaged by a protrusion of a packing. A backup ring 10 comprises a first ring portion 11 of an inner peripheral side and a second ring portion 12 of an outer peripheral side, the first ring portion 11 and the second ring portion 12 are respectively provided with tapered surfaces, the tapered surfaces slide on each other, the first ring portion 11 and the second ring portion 12 can move in a radial direction, a diameter size of the backup ring 10 is set such that an inner diameter of the backup ring 10 is smaller than a diameter size of a mounting space and an outer diameter of the backup ring 10 is greater than the diameter size of the mounting space.

### BACKGROUND OF THE INVENTION

1. Field of the Invention

The present invention relates to a backup ring for a sealing apparatus used for a hydraulic cylinder and the like, and more particularly, to a backup ring mounted between a seal member and a low pressure-side sidewall of a mounting groove in which the seal member is mounted.

1. Description of the Related Art

As shown in FIGS. 6A and 6B, a conventional sealing apparatus used for a hydraulic cylinder and the like includes a U-shaped packing 120 and a backup ring 110, and an annular gap between a housing 130 having a shaft hole and a shaft 140 inserted into the shaft hole is sealed.

FIGS. 6A and 6B are schematic sectional views of a sealing apparatus according to the related art, wherein FIG. 6A is a schematic sectional view showing a mounting state when no pressure is applied, and FIG. 6B is a schematic sectional view showing a mounting state when a pressure is applied.

The backup ring 110 is mounted between the U-shaped packing 120 and the low pressure-side sidewall 132 of the mounting groove 131. The backup ring 110 prevents a heel portion 121 of the U-shaped packing 120 from protruding into the annular gap between the housing 130 and the shaft 140 (portion surrounded by D in FIG. 6B), and also prevents the U-shaped packing 120 from being damaged due to the protrusion.

Here, as shown in FIGS. 7A and 7B, a cross section width of the backup ring 110 (difference between inner diameter and outer diameter) is reduced in some cases as compared with a width of a mounting space in a radial direction (radial distance from a bottom surface of the mounting groove 131 to an outer peripheral surface of the shaft 140) due to tolerance of size and the like generated when the backup ring 110 or the mounting groove 131 is machined, and a gap 106 may be produced between inner and outer peripheral surfaces of the backup ring 110, a bottom surface of the mounting groove 131 and the shaft 140 (FIG. 7A). If such a gap is generated, a portion of the heel portion 121 of the U-shaped packing 120 protrudes into the gap 106 when it is pressed (portion surrounded by E and F in FIG. 7B), and the U-shaped packing 120 is damaged due to the protrusion of the heel portion 121 into the gap 106. As a product to be machined becomes greater, it becomes more necessary to increase the tolerance of size to some extent. Therefore, in a large product, such a problem is prone to be generated.

As a technique for solving this problem, FIGS. 8A to 8C show a technique for preventing the U-shaped packing 120 from protruding by dividing the backup ring 110 into an inner peripheral side and an outer peripheral side by a tapered dividing surface, by sliding the inner peripheral side and the outer peripheral side of the backup ring 110 in a direction in which the gap 106 is filled up by sliding motion of the dividing surface (FIG. 8B), and filling up the gap 106.

### SUMMARY OF THE INVENTION

Although the gap 106 is filled up by the sliding motion of the backup ring 110 (portion surrounded by H in FIG. 8B), a recessed step is generated at the divided portion (portion shown with I in FIG. 8C). If the step is generated, the heel portion 121 of the U-shaped packing 120 protrudes into the step, and the heel portion 121 of the U-shaped packing 120 is damaged (bitten).

The present invention has been accomplished to solve the problem of the conventional technique, and it is an object of the invention to provide a backup ring capable of preventing the backup ring from being damaged by a protrusion of a packing.

To achieve that object, the present invention provides a backup ring mounted between a seal member used for sealing an annular gap and a low pressure-side sidewall of a mounting groove in which the seal member is mounted, the backup ring comprising:

a first ring portion of an inner peripheral side and a second ring portion of an outer peripheral side, wherein

the first ring portion and the second ring portion are respectively provided with tapered surfaces, the tapered surfaces slide on each other, the first ring portion and the second ring portion can move in a radial direction,

a diameter size of the backup ring is set such that an inner diameter of the backup ring is smaller than a diameter size of a mounting space and an outer diameter of the backup ring is greater than the diameter size of the mounting space.

According to the above structure, the backup ring is mounted in the mounting space without generating a gap in the radial direction. Since the backup ring has a fastening margin in the radial direction in the mounting space, even if the size of the mounting space in the radial direction is varied due to the influence of the tolerance of size, the backup ring does not generate a gap in the mounting space in the radial direction. Therefore, it is possible to reliably prevent a seal member from protruding into the gap.

It is preferred that the entire outer peripheral side of the first ring portion is a tapered surface, the entire inner peripheral side of the second ring portion is a tapered surface which slides on the tapered surface of the first ring portion, an end surface of the first ring portion on the seal member side and an end surface of the second ring portion on the seal member side are on the same plane before the backup ring is mounted.

A fastening margin is set in the backup ring in the radial direction. Thus, when it is mounted, a first ring portion is stretched radially outwardly from the inner peripheral side and a second ring portion is compressed radially inwardly from the outer peripheral side. The tapered surfaces slide against each other with the variations in diameters, and the first ring portion and the second ring portion are deviated in the axial direction. As a result, an end surface of the first ring portion and an end surface of the second ring portion are deviated from each other in the axial direction, an end edge of the tapered surface projects toward the seal member and a step is generated, but since the end edge projecting toward the seal member is deformed in a smooth convex shape by pressing force received from the seal member at when a pressure is applied, a protrusion damage due to the step is not generated.

Even when a diameter size of the mounting space is varied due to the influence of the tolerance of size and the like and the fastening margin is reduced, this only reduces the projecting amount of the end edge of the tapered surface, and the recessed step is prevented from being generated unlike the conventional technique. Further, even if a force received from the seal member is increased and the first ring portion is pushed against the inner peripheral side and the second ring portion is pushed against the outer peripheral side, the projecting amount of the end edge of the tapered surface is reduced but the recessed step is prevented from being generated as in the case where the fastening margin is reduced. Therefore, it is possible to prevent the packing from being bitten by the step.

As explained above, according to the present invention, being damaged due to a protrusion of a packing can be prevented.

### BRIEF DESCRIPTION OF THE DRAWINGS

FIG. 1 is a schematic sectional view showing a state where a backup ring of an embodiment of the invention is applied to a sealing apparatus for a hydraulic cylinder;

FIGS. 2A and 2B are schematic diagrams showing a structure of the backup ring of the embodiment of the invention;

FIG. 3 is a schematic sectional view of the backup ring of the embodiment of the invention;

FIG. 4 is a schematic sectional view showing a mounting state of the backup ring (when no pressure is applied) according to the embodiment of the invention;

FIGS. 5A and 5B are schematic sectional views showing a mounting state of the backup ring (when a pressure is applied) according to the embodiment of the invention;

FIGS. 6A and 6B are schematic sectional view of a backup ring of a conventional technique;

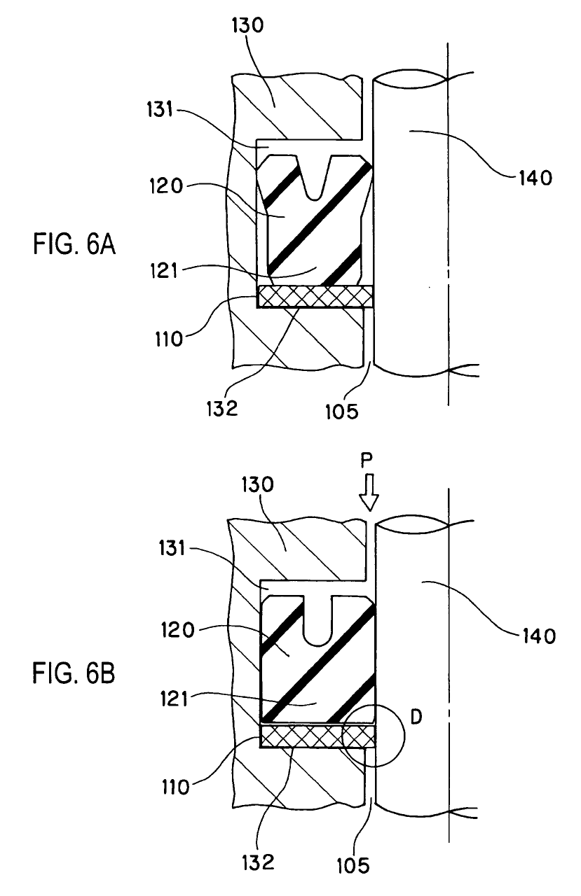

FIGS. 7A and 7B are schematic sectional view of a backup ring of another conventional technique; and

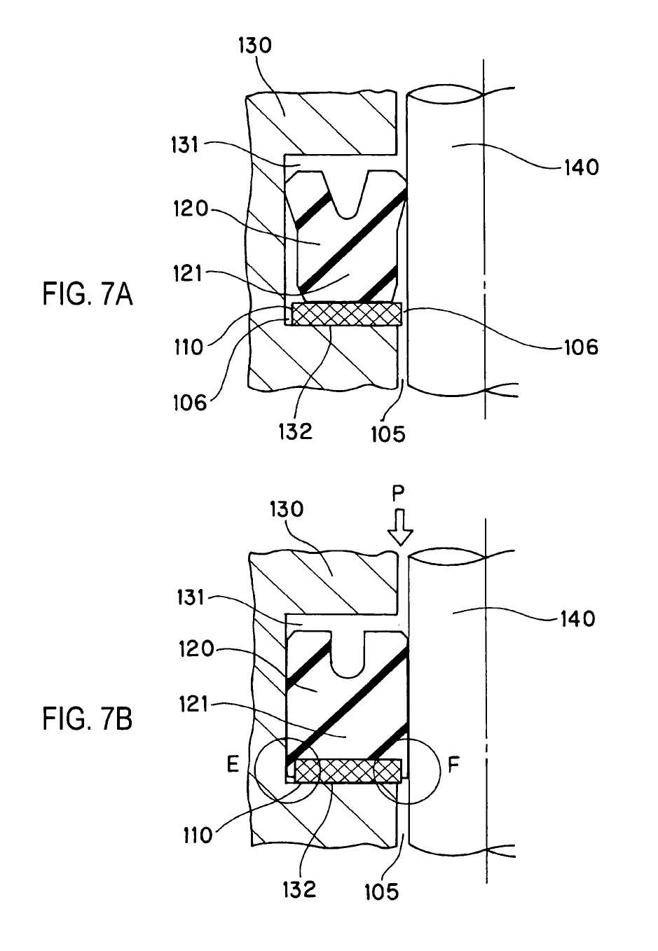

FIGS. 8A to 8C are schematic sectional view of a backup ring of another conventional technique.

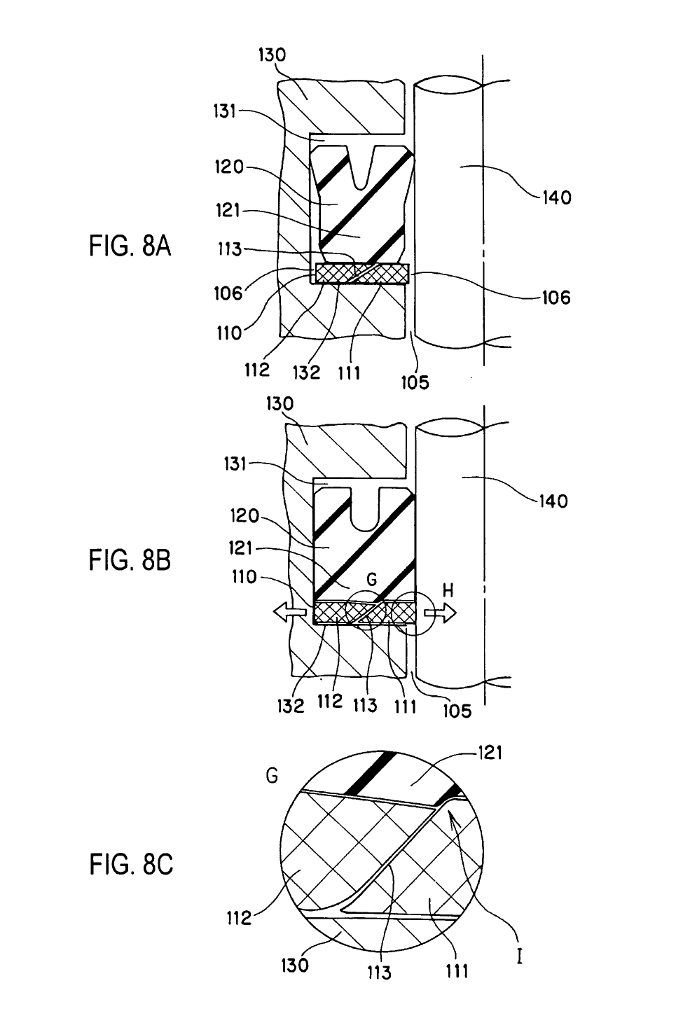

### DESCRIPTION OF THE PREFERRED EMBODIMENT

The best mode for carrying out the invention will be explained in detail based on embodiments with reference to the drawings. Size, material, shape and relative disposition of each of constituent parts are described in the embodiments, but the invention is not limited to them unless otherwise specified.

First Embodiment

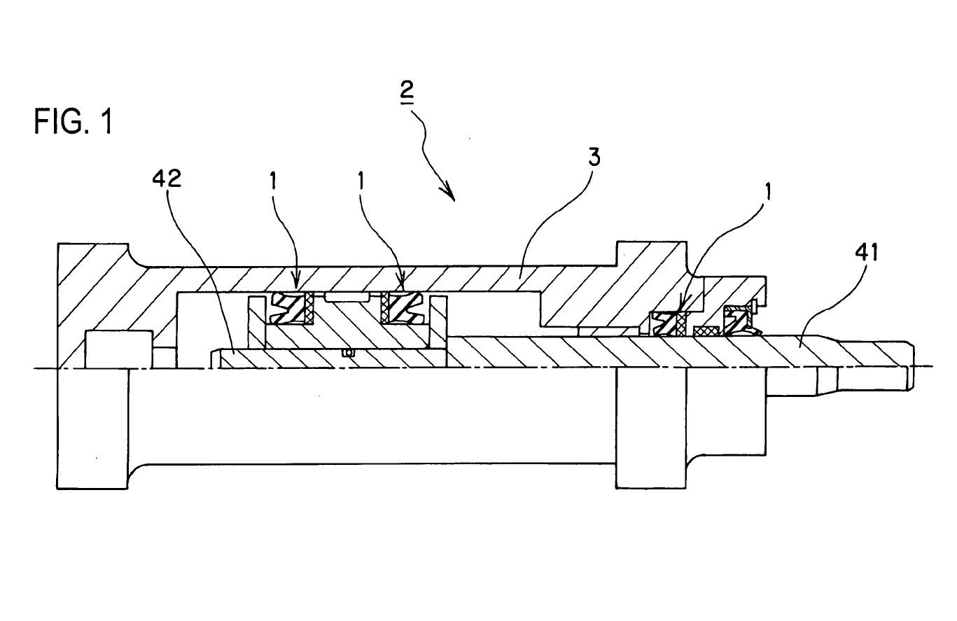

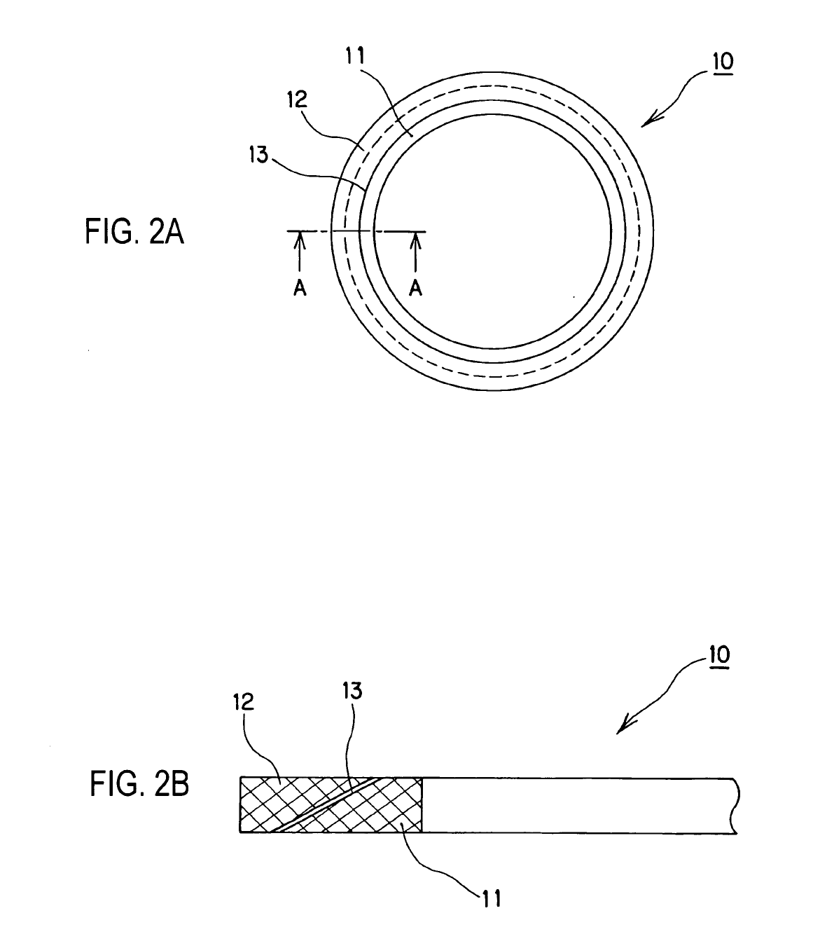

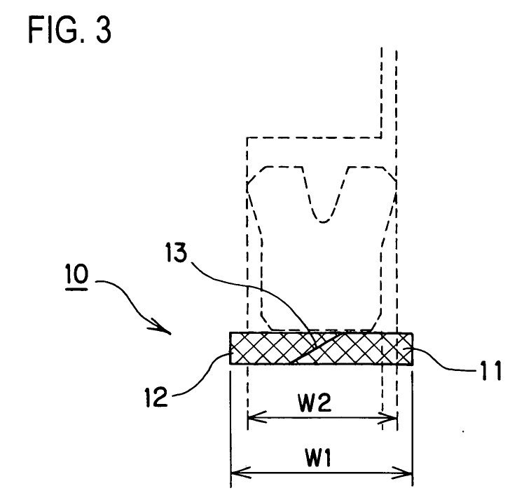

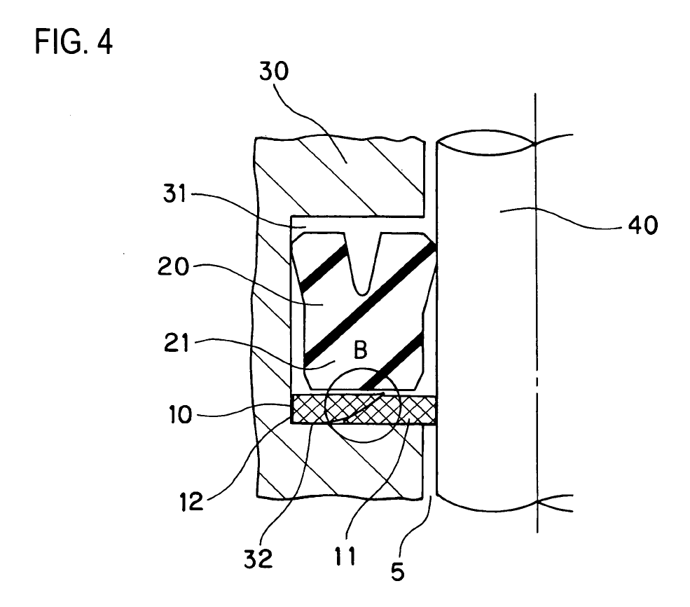

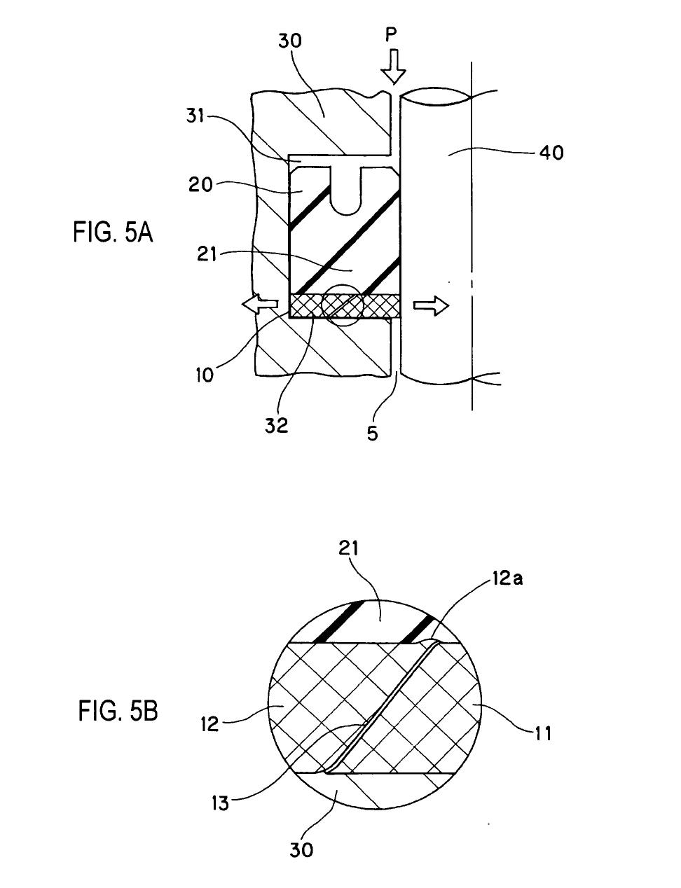

A backup ring according to an embodiment of the invention will be explained with reference to FIGS. 1 to 5. FIG. 1 is a schematic sectional view showing a state where a backup ring of the embodiment of the invention is applied to a sealing apparatus for a hydraulic cylinder. FIGS. 2A and 2B are schematic diagrams showing a structure of the backup ring of the embodiment of the invention, wherein FIG. 2A is a schematic plan view and FIG. 2B is a schematic partially cut-away sectional view. FIG. 3 is a sectional view taken along the line A-A in FIG. 2A. FIG. 4 is a schematic sectional view showing a mounting state of the backup ring when no pressure is applied according to the embodiment of the invention. FIGS. 5A and 5B are schematic sectional views of the backup ring of the embodiment of the invention, wherein FIG. 5A is a schematic sectional view showing the mounting state where a pressure is applied, and FIG. 5B is a schematic enlarged view of a portion surrounded by C in FIG. 5A.

The backup ring according to the embodiment of the invention is, for example, suitably used for a hydraulic cylinder as shown in FIG. 1 as one constituent member of a sealing apparatus. The hydraulic cylinder 2 includes a cylinder 3, a rod 41, a piston 42 and the like. The sealing apparatus 1 seals an annular gap between the cylinder 3, the rod 41 and the piston 42.

As shown in FIG. 4, the sealing apparatus 1 includes a U-shaped packing (seal member) 20 and a backup ring 10. The U-shaped packing 20 is mounted on an annular mounting groove 31 formed in a housing 30 (cylinder 3). The backup ring 10 is mounted between a low pressure-side end surface of the heel portion 21 of the U-shaped packing 20 and the low pressure-side sidewall 32 of the mounting groove 31. The backup ring 10 prevents the heel portion 21 of the U-shaped packing 20 from protruding into a gap 5 formed between an inner peripheral surface of the shaft hole of the housing 30 and an outer peripheral surface of the shaft 40 due to reciprocating motion of the shaft 40 (rod 41 or piston 42) in the axial direction.

As shown in FIG. 2, the backup ring 10 of the embodiment is a ring-like member having a substantially rectangular cross section, and made of synthetic resin such as PTFE (polytetrafluoroethylene resin). As shown in FIG. 2B, the backup ring 10 includes a first ring portion 11 on the inner peripheral side and a second ring portion 12 on the outer peripheral side. The first ring portion 11 and the second ring portion 12 are slidably and integrally formed together through sliding surfaces 13.

The entire outer peripheral side of the first ring portion 11 is a tapered surface. The entire inner peripheral side of the second ring portion 12 is a tapered surface which can slide on the tapered surface of the first ring portion 11. These tapered surfaces abut against each other, thereby forming the sliding surfaces 13. The end surface of the first ring portion 11 in the axial direction and the end surface of the second ring portion 12 in the axial direction are on the same plane before they are mounted, and they form one continuous surface.

In the backup ring 10 according to the embodiment, the inner diameter of the first ring portion 11 is set smaller than the outer diameter of the shaft 40, and the outer diameter of the second ring portion 12 is set greater than diameter of a bottom of the mounting groove. That is, as shown in FIG. 3, a cross section width W1 of the backup ring 10 (difference between the inner diameter and the outer diameter) is set larger than a width W2 of the space in which the backup ring 10 is mounted in the radial direction (distance from the bottom of the mounting groove 31 to the outer peripheral surface of the shaft 40 in the radial direction). The backup ring 10 has a fastening margin with respect to the mounting space in the radial direction.

Therefore, even when tolerances of sizes of the mounting groove 31 of the housing 30, the shaft 40 and a combination thereof become large and the width W2 of the mounting space in the radial direction becomes large, the backup ring 10 is mounted such that its inner peripheral surface and outer peripheral surface come into intimate contact with the mounting groove 31 and the shaft 40. Therefore, no gap is generated between the inner and outer peripheral surfaces, the bottom of the mounting groove 31 and the outer peripheral surface of the shaft 40. That is, it is possible to reliably prevent the heel portion 21 of the U-shaped packing 20 from protruding without receiving the influence of the tolerance of size.

At the time of the mounting operation, since the fastening margin is provided, the first ring portion 11 is pushed against the outer peripheral side of the shaft 40, the first ring portion 11 is stretched radially outwardly from the inner peripheral side, the second ring portion 12 is pushed against the bottom surface of the mounting groove 31 and compressed radially inwardly from the outer peripheral side. The sliding surfaces 13 slides in accordance with variations in diameters caused by a diameter-increasing deformation of the first ring portion 11 and a diameter-reducing deformation of the second ring portion 12. With this, the backup ring 10 is mounted such that the first ring portion 11 and the second ring portion 12 are deviated from each other in the axial direction as shown in FIG. 4. As a result, the end surface of the first ring portion 11 and the end surface of the second ring portion 12 located on the same plane are deviated from each other in the axial direction, the end edge of the tapered surface protrudes in the axial direction, and a step is generated (portion surrounded by B in FIG. 4).

In the embodiment, the sliding surfaces 13 are comprised of the tapered surfaces which are inclined radially inwardly from the low pressure-side end surface and which reach the high pressure-side end surface. Therefore, the second ring portion 12 is deviated toward the seal member with respect to the first ring portion 11. Thus, the end edge of the tapered surface of the second ring portion 12 on the side of the seal member side projects toward the seal member.

The end edge of the second ring portion 12 projects toward the seal member and the step is generated in this manner, but if a pressure is applied when it is used, the projecting end edge of the second ring portion 12 is pressed by the heel portion 21 of the U-shaped packing 20 and is deformed into a smooth convex shape 12a as shown in FIG. 5B. Therefore, the heel portion 21 of the U-shaped packing 20 does not protrude into the step, and the heel portion 21 is not damaged (bitten).

Even when the width W2 of the mounting space in the radial direction is increased due to influence of the tolerance of size and the like and the fastening margin is reduced, this only reduces the projecting amount of the end edge of the tapered surface of the second ring portion 12, and it is possible to prevent the concave step from being generated between the first ring portion 11 and the second ring portion 12 unlike the conventional technique. Thus, it is possible to prevent the heel portion 21 of the U-shaped packing 20 from being bitten by the step.

Even if the pressing force received from the U-shaped packing 20 is increased and the first ring portion 11 is further pressed against the inner peripheral side and the second ring portion 12 is further pressed against the outer peripheral side, the projecting amount of the end edge of the tapered surface of the second ring portion 12 is reduced as in the case where the fastening margin is reduced, but the concave step is prevented from being generated, and the bite by the step can be suppressed.

It is preferable that a difference between a tolerance minimum value of the cross section width W1 of the backup ring 10 and a tolerance maximum value of the width W2 of the mounting space is 0.05 mm or greater. That is, when the tolerance of size is taken into consideration, it is preferable that the backup ring 10 has the fastening margin of at least 0.05 mm with respect to a size of the mounting space in the radial direction.

The backup ring of the embodiment has compatibility with a general conventional backup ring, and the backup ring of the embodiment can be used without changing sizes of the U-shaped packing and mounting groove or the like. Therefore, it is possible to obtain the effect of the invention while using the conventional sealing apparatus.

Although the mounting groove is formed on the side of the housing in the embodiment, the effect of the invention can of course be obtained even if the mounting groove is formed on the side of the shaft.

Although the tapered surfaces forming the sliding surfaces are inclined radially inwardly from the low pressure-side end surface (or is inclined from the high pressure-side end surface radially outwardly) in the embodiment, the same effect can of course be obtained even when the tapered surfaces are inclined radially inwardly from the high pressure-side end surface (or is inclined radially outwardly from the low pressure-side).

This application claims the benefit of Japanese Patent Application No. 2005-260278, filed on 8 Sep. 2005, which is hereby incorporated by reference herein in its entirety.

### DESCRIPTION OF REFERENCE NUMERALS

Backup ring
First ring portion
Second ring portion
Sliding surface
U-shaped packing (seal member)
Heel portion
Housing
Mounting groove
Mounting groove sidewall
Shaft
Annular gap

What is claimed is:

1. A backup ring mounted between a seal member used for sealing an annular gap and a low pressure-side sidewall of a mounting groove in which the seal member is mounted, the backup ring comprising:
a first ring portion of an inner peripheral side and a second ring portion of an outer peripheral side, wherein
the first ring portion and the second ring portion are respectively provided with tapered surfaces, the tapered surfaces slide on each other, the first ring portion and the second ring portion can move in a radial direction,
a diameter size of the backup ring is set such that an inner diameter of the backup ring is smaller than a diameter size of a mounting space and an outer diameter of the backup ring is greater than the diameter size of the mounting space.

2. The backup ring according to claim 1, wherein the entire outer peripheral surface of the first ring portion is a tapered surface,
the entire inner peripheral surface of the second ring portion is a tapered surface which slides on the tapered surface of the first ring portion,
an end surface of the first ring portion on the seal member side and an end surface of the second ring portion on the seal member side are on the same plane before the backup ring is mounted.
